(19) United States
(12) Patent Application Publication
(10) Pub. No.: US 2005/0008254 A1
(43) Pub. Date: Jan. 13, 2005

(54) Image generation from plurality of images

(76) Inventors: Makoto Ouchi, Nagano-ken (JP); Naoki Kuwata, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/821,650

(22) Filed: Apr. 9, 2004

(30) Foreign Application Priority Data
Apr. 15, 2003 (JP) 2003-110450
Mar. 31, 2004 (JP) 2004-102035

(51) Int. Cl. G06T 5/50; G06T 3/40; G06T 7/60; H04N 1/387

(52) U.S. Cl. 382/284; 358/450; 382/299; 382/282

(57) ABSTRACT

When synthesizing a plurality of images that partially overlap one another to derive a larger image, the target larger image can be derived with less processing. First, a plurality of first images mutually including portions recording the same given subject are prepared (S2). Next, each first image is subjected to resolution conversion, to generate a second image with lower pixel density (S4). Then, based on portions recording the same subject, relative positions of the second images are calculated (S6). After that, an image generation area is determined, within a composite area which is the sum of areas recorded by the second images (S8). Then, first partial images, which are portions of the second images included in the image generation area, are determined (S10). After that, second partial images, which are part of the first images and correspond to the first partial images, are determined (S12). Finally, third images are generated based on the second partial images (S14).

### BACKGROUND OF THE INVENTION

1. Field of the Invention

This invention relates to a technique for synthesizing a plurality of images that partially overlap one another, to obtain a larger image; and in particular has as an object to obtain a larger image with a less burden of processing.

2. Description of the Related Art

Techniques for synthesizing a plurality of digital photographs that partially overlap one another, to produce a larger panorama image have been in existence for some time. For example, JP09-91407A discloses a technique for producing a panorama image by extracting an image of predetermined range from a composite image. A related technique is disclosed in JP3302236B.

However, the techniques mentioned above require considerable amounts of processing in order to synthesize a plurality of digital images. Additionally, considerable computer memory is required, and processing is time-consuming.

In view of the above-described problems pertaining to the prior art, it is an object of the present invention to obtain an image with a less amount of processing, when synthesizing a plurality of images that partially overlap one another to derive an image.

### SUMMARY OF THE INVENTION

To address the aforementioned problems at least in part, in the present invention, the following process is carried out when generating a panorama image from a plurality of original images that include images in common. First, from the original images, low-resolution images each of which has lower resolution than the corresponding original image are generated. A condition of overlap for the low-resolution images which is to be identified is identified based on areas for the image in common. By doing so, a feasible area in which the panorama image may be generated is determined. Then within the feasible area an area extending beyond an area of any one of the low-resolution images is determined as an image generation area for generating the panorama image. From the plurality of original images a panorama image having an area corresponding to the image generation area is generated. According to this aspect, when synthesizing a plurality of images that partially overlap one another to derive a larger image, the image can be derived with less processing.

An aspect such as the following may be employed when generating a composite image from a plurality of original images. First, a plurality of partial original images for inclusion in the composite image to be generated, and included in any of the plurality of original images are determined. A predetermined process for generating the composite image is performed on a predetermined processing area of the original image that includes the partial original image, without performing the process on portions outside the processing area, to generate the composite image based on the plurality of partial original images. With this embodiment as well, when synthesizing a plurality of images that partially overlap one another to derive a larger image, the image can be derived with less processing.

The processing area may include: an area included within the original image and within a range of predetermined distance from the perimeter of the partial image, and the area of the partial original image. The processing area may also be equivalent to the area of the partial original image.

Where a plurality of original images include among them portions recording a same given subject, a process such as the following may be employed when determining partial original images. First, resolution conversion for the plurality of original images is performed to generate a plurality of low-resolution images of resolution lower than the original images. Based on portions in the low-resolution image recording the same given subject, a composite area equivalent to the sum of the areas of the low-resolution images is determined from the areas of the plurality of low-resolution images. Then an image generation area extending beyond an area of any one of the low-resolution images is determined within the composite area. As the partial original images, portions of the original images corresponding to low-resolution partial images are determined. The low-resolution partial images are portions of the low-resolution images and are included in the image generation area are determined.

In an aspect of this kind, low-resolution images are used initially to determine portions needed to generate a new image. The new image is then generated based on those required portions. It is accordingly possible to derive a new image with less processing, as compared to the case where synthesis is carried out for all images, including unnecessary portions thereof.

When determining a composite area, it is preferable to calculate relative positions of the plurality of low-resolution images based on portions thereof recording the same given subject. First, the plurality of low-resolution images is displayed as the composite area on a display unit according to the relative positions thereof. The image generation area is provisionally established. Then the provisionally established image generation area is displayed on the display unit, shown superimposed on the plurality of low-resolution images. In some occasions, the image generation area is reset. Then the reset image generation area is determined as the image generation area. By doing so, the image generation area can be established considering its extent or size in the composite area.

When calculating relative positions of low-resolution images, an aspect such as the following is preferred. First, user instruction in regard to general relative position of the plurality of low-resolution images is received. Based on relative position instructed by the user, relative position of the plurality of low-resolution images is calculated so that deviation among portions thereof recording the same given subject is within a predetermined range. By means of such an aspect, the number of calculations needed when determining relative positions of low-resolution images is reduced.

In the present invention, the above-mentioned problems may be addressed at least in part by carrying out the following process when generating an image. Specifically, first, a plurality of partial original images for inclusion in a composite image to be generated, and contained in any of a plurality of original images, are determined. Then, a predetermined process for generating the composite image is performed for the plurality of partial original images—but not for portions of original images other than these partial original images—to generate the composite image based on the plurality of partial original images.

An aspect such as the following is also preferred. First, as the plurality of original images, there are prepared a plurality of first images having relatively high density of pixels making up the image, and including among themselves portions that record a same given subject. Resolution of each of the first images is then converted, to generate a plurality of second images having relatively low density of pixels making up the image, and including among themselves portions that record a same given subject. Relative positions of the plurality of second images are then calculated based on the portions thereof recording the same given subject. There is then determined an image generation area composed of an area that is included within a composite area composed of areas in the second images, and that extends beyond the area of any one of the plurality of second images. Next, a plurality of first partial images which are images contained within the image generation area of the second images is determined.

Next, a plurality of second partial images serving as the plurality of partial original images are determined based on relationships among the first partial images and second images, and on the plurality of first images. Second partial images are included in any of the first images, and represent images that can generate images equivalent to first partial images when resolution conversion is performed. Then, as the composite image, there is generated a third image having relatively high density of pixels making up the image, and having an area extending beyond the area of any one of the plurality of first images.

In this aspect, portions required for generating a new image are determined first, and the new image is then generated based on those required portions. It is accordingly possible to derive a new image with less processing, as compared to the case where synthesis is carried out for all images, including unnecessary portions thereof

The predetermined process for generating a composite image may be calculating tone values of pixels, for example. In preferred practice, when generating the third image, tone values for the pixels that make up the third image will be calculated based on tone values of the pixels that make up the plurality of second partial images, without calculating tone values for pixels that are not included within the third image. By means of such an aspect, the amount of processing can be reduced, by not performing calculations not required for generating the third image.

When determining an image generation area, the following is preferred. The plurality of second images are displayed on a display unit, according to the relative positions of the plurality of second images. An image generation area is then provisionally established. The provisionally established image generation area is then shown on the display, superimposed over the plurality of second images. In certain predetermined instances, the provisionally established image generation area setting is cancelled. In other instances, the provisionally established image generation area is selected as the image generation area. By so doing, it is possible to establish an image generation area in consideration of the relative positions of the second images.

When calculating relative positions of second images, it is preferable to receive user instructions regarding relative positions of the plurality of second images. By means of such an aspect, the amount of processing is reduced when determining relative positions of second images.

In preferred practice, at least two of the plurality of second images will be displayed on the display unit when receiving user instructions regarding relative positions of the plurality of second images. Preferably, at least some of the instructions regarding relative positions of the plurality of second images will be made by means of the user dragging one of the two or more second images displayed on the display unit, so that it partially overlaps another second image. By means of such an aspect, instructions effective in determining relative positions of second images may be issued by means of a simple procedure.

There may also be employed an aspect wherein, when receiving user instructions regarding relative positions of second images, an instruction relating to the order of a number of second images in a predetermined direction serves as the instruction regarding relative positions of the plurality of second images. In this case, when calculating relative positions of a plurality of second images, relative positions of the plurality of second images will be determined according to that order. Such an aspect is particularly advantageous in cases where first images are a plurality of images of a predetermined subject, shot while panning in one direction.

In preferred practice, second images will have pixel pitch equivalent to 30%-80% of pixel pitch in first images. By means of such an aspect, the amount of processing needed when calculating relative position of second images is reduced.

The invention may be realized as many aspects, as indicated hereinbelow.

(1) Image generating method, image processing method, image data generating method.

(2) Image generating device, image processing device, image data generating device.

(3) Computer program for realizing any of the aforementioned methods or devices.

(4) Recording medium having recorded thereon a computer program for realizing any of the aforementioned methods or devices.

(5) Data signals which comprise a computer program for realizing any of the aforementioned methods or devices and are embodied inside a carrier wave.

These and other objects, features, aspects, and advantages of the present invention will become more apparent from the following detailed description of the preferred embodiments and the accompanying drawings.

### BRIEF DESCRIPTION OF THE DRAWINGS

FIG. 1 illustrates a simplified arrangement of an image processing device as a embodiment of the invention;

FIG. 2 is a flowchart showing a procedure for generating still image data representing a still image, from a plurality of frame images of motion video data;

FIG. 3 is an illustration of the relationship between a photographed landscape and image ranges of original image data F1, F2;

FIG. 4 illustrates a method for identifying relative position of low-resolution data;

FIG. 5 illustrates a user interface screen displayed when calculating relative position of low-resolution data FL1, FL2 images in Step S6;

FIG. 6 illustrates a user interface screen for determining image generation area;

FIG. 7 is an illustration of the relationship between images of original image data F1, F2 and partial images Ap1, Ap2;

FIG. 8 is a flowchart showing a procedure when calculating tone values of pixels of a panorama image Fc in Step S6;

FIG. 9 is an illustration of relationships among tone values of pixels of an image within partial image Ap1 in original image F1, tone values of pixels of converted partial image Ap2r, and tone values of pixels of panorama image Fc;

FIG. 10 is an illustration of the relationship between the range of panorama image Fc1 and the ranges of original image data F1, F2 images;

FIG. 11 is a flowchart showing a procedure for calculating tone values of pixels of panorama image Fc from tone values of pixels of partial images Ap1, Ap2;

FIG. 12 illustrates a user interface screen displayed when determining an image generation area ALc on the basis of low-resolution data FL3, FL4, FL5 displayed on display 110, in Embodiment 3; and

FIG. 13 is an illustration of relationships among original image data F1, F2 images, partial images Ap1, Ap2, and processing areas Ap1′, Ap2′.

### DETAILED DESCRIPTION OF THE PREFERRED EMBODIMENTS

The following description of the embodiments of the invention on the basis of embodiments follows the order indicated below.

A. Embodiment 1:
A-1. Device Arrangement:
   A-2. Image Processing:

B. Embodiment 2:

C. Embodiment 3:

D: Variations

### A. Embodiment 1

A-1. Device Arrangement:

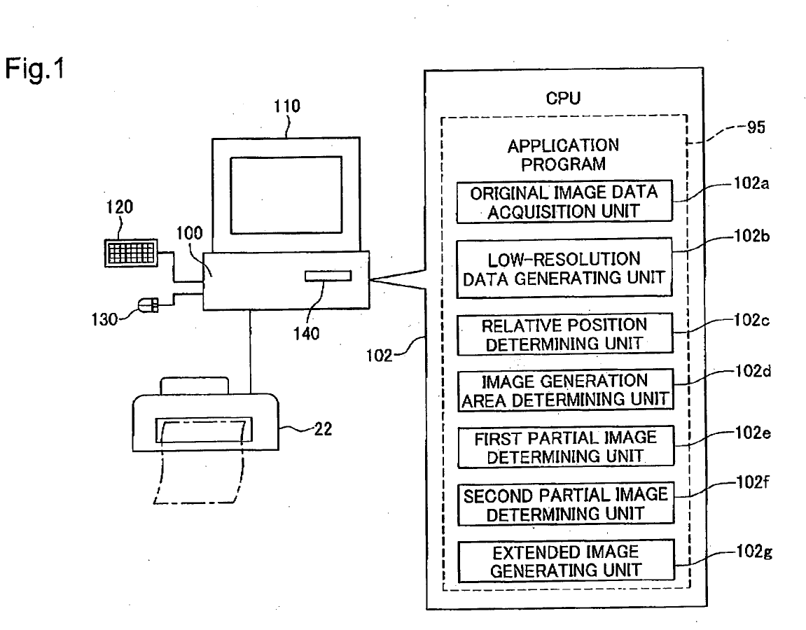

FIG. 1 illustrates a simplified arrangement of an image processing device as a embodiment of the invention. This image processing device comprises a personal computer 100 for performing predetermined image processing on image data; a keyboard 120, mouse 130 and CD-R/RW drive 140 as devices for inputting information to personal computer 100; and a display 110 and printer 22 as devices for outputting information. An application program 95 that operates on a predetermined operating system loaded onto computer 100. By running this application program 95, the CPU 102 of computer 100 realizes various functions.

When an application program 95 for performing image retouching or the like is run and user commands are input via the keyboard 120 or mouse 130, CPU 102 reads image data into memory from a CD-RW in the CD-R/RW drive 140. CPU 102 then performs predetermined image process on the image data, and displays the image on display 110 via the video driver. CPU 102 may also print image data that has undergone image processing, by sending it to the printer 22 via the printer driver.
A-2. Image Processing:

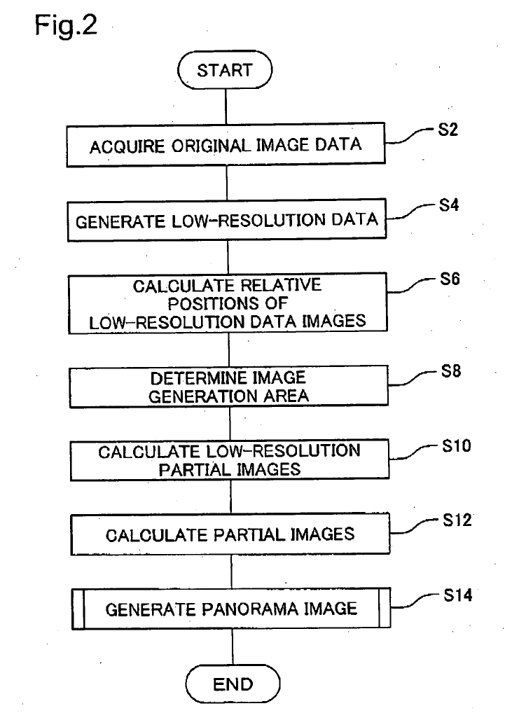

FIG. 2 is a flowchart showing a procedure for generating still image data representing a still image, from a plurality of frame images of motion video data. When application program 95 is run and user commands are input via the keyboard 120 or mouse 130, in Step S2 CPU 102 first acquires data for a plurality of original images from a CD-RW in the CD-R/RW drive 140. Here, let it be assumed that sets of original image data F1, F2 are read out. The functions of receiving user instructions and acquiring data for a plurality of original images in this way are executed by an original image data acquisition unit 102a (see FIG. 1) which is a functional portion of CPU 102.

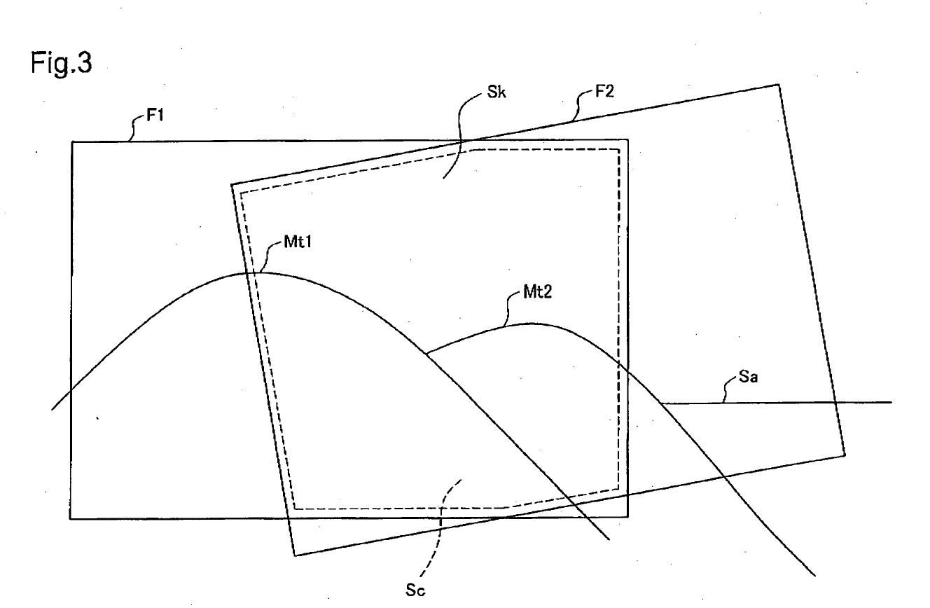

FIG. 3 is an illustration of the relationship between a photographed landscape and image ranges of original image data F1, F2. Original image data consists of image data shot with a photographic device such as a digital camera, capturing a still subject, such as a landscape, still life, or the like. An original image data image is composed of a plurality of pixels, each pixel having tone values that represents color. For example, pixels may have tone values for the three colors red, green, and blue.

Original image data also represents data taken of a subject that exceeds the range photographable by the photographic device in one shot, in the form of several images taken in several shots. As a result, the plurality of sets of original image data acquired in Step S2 each include the same given subject in the still images represented thereby, with the photographed subject shifted in position among image planes (frames). For example, in the example of FIG. 3, original image data F1 is image data of a landscape that includes mountains Mt1, Mt2, sky Sk, and ocean Sa, shot in a range situated relatively leftward. Original image data F2 is image data of the same landscape, shot in a range situated relatively rightward. Original image data F1, F2 both include images of the same subject, i.e. portions of mountains Mt1, Mt2, and sky Sk. Portion Sc indicated by the broken lines represents portions of original image data F1, F2 images in which the same subject is recorded.

In Step S4 in FIG. 2, resolution conversion is performed on the original image data acquired in Step S2, to generate low-resolution data having low pixel density. Here, let it be assumed that low-resolution image data FL1, FL2 is generated from original image data F1, F2 respectively. Low-resolution image data FL1, FL2 generated in this way includes in common images of the same subject, i.e. portions of mountains Mt1, Mt2, and sky Sk.

Let it be assumed that pixel density in low-resolution image data FL1, FL2 is 50% of pixel density in the original image data F1, F2. The function of generating low-resolution data in this manner is realized by a low-resolution data generating unit 102b (see FIG. 1) which is a functional portion of CPU 102.

Herein, “low pixel density” signifies the following. Where the same given subject is included in both a first image and a second image, when the number of pixels required to represent the subject in the second image is smaller than the number of pixels required to represent the subject in the first image, the second image is deemed to have “lower pixel density” than the first image. On the other hand, when the number of pixels required to represent the subject in the second image is greater than the number of pixels required to represent the subject in the first image, the second image is deemed to have “higher pixel density” than the first image.

Where the number of pixels required to represent the subject in a first image and the number of pixels required to represent the subject in a second image are each counted in the same pixel array direction, and the number of pixels in the second image is p % of the number of pixels in the first image, this is referred to as “second image pixel pitch being p % of first image pixel pitch.”

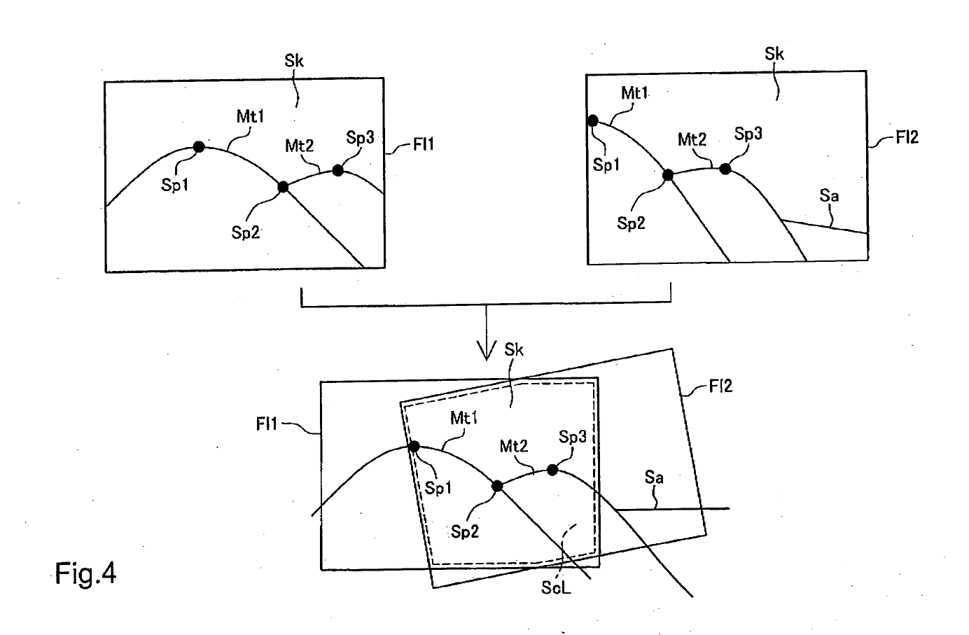

FIG. 4 illustrates a method for identifying relative position of low-resolution data. In Step S6 in FIG. 2, relative position of low-resolution data FL1, FL2 images is calculated based on portions within the low-resolution data FL1, FL2 images in which the same subject is recorded. Identification of relative position of each low-resolution data image is carried out as follows. The portion ScL indicated by the broken lines in FIG. 4 represents portions of low-resolution data FL1, FL2 images in which the same subject is recorded.

First, characteristic points are established in the portion of each image in which the same subject is recorded. Characteristic points are represented by black dots Sp1-Sp3 in the low-resolution data FL1, FL2. Characteristic points can be placed in characteristic image portions that do not often appear in typical images. For example, in FIG. 4, both sets of low-resolution data FL1, FL2 include as the same subject two mountains Mt1, Mt2, and sky Sk. Here, the peaks (Sp1, Sp3) of mountain Mt1 and mountain Mt2, or the intersection point (Sp2) of the outlines of mountain Mt1 and mountain Mt2 could be designated as characteristic points, for example.

More specifically, a method such as the following could be employed when extracting characteristic points. First, an edge in the image is extracted by means of differentiation or applying a Sobel or other edge extraction filter. An SRA (side effect resampling algorithm) is then applied to the extracted edge, designating the resultant point as a characteristic point.

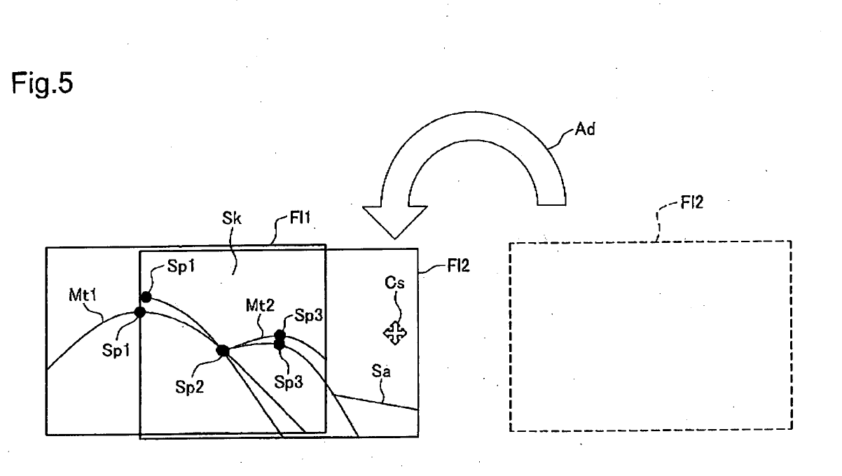

FIG. 5 illustrates a user interface screen displayed when calculating relative position of low-resolution data FLI, FL2 images in Step S6. In Step S6, the low-resolution data FLI, FL2 images are displayed on display 110 (see FIG. 1). Using the mouse 130, the user drags the image of either low-resolution data FLI or FL2 onto the other as indicated by arrow Ad, superimposing them so that images in the portions included in both low-resolution data FLI, FL2 images are aligned as closely as possible. In the example of FIG. 5, the low-resolution data FL2 image has been dragged onto the low-resolution data FLI image so that the outlines of mountain Mt1, Mt2 are superimposed as much as possible. In FIG. 5, Cs denotes the mouse cursor.

Once the user has superimposed the low-resolution data FLI, FL2 images using the mouse 130, the CPU 102 then performs shifting, rotation, and enlargement or reduction of images so that deviation among the positions of characteristic points is brought to with a predetermined range, to determine the relative positions of the low-resolution data FLI, FL2 images. Shifting, rotation, and enlargement or reduction of images may be carried out by means of affine conversion. As a result, relative positions of the low-resolution data FLI, FL2 images are shown at bottom in FIG. 4.

“Identifying relative position” herein refers not only to an aspect wherein shifting and rotation of images are performed to identify relative position, but also an aspect wherein enlargement or reduction of images is performed in addition to shifting and rotation of the images to identify relative position of the images. This applies analogously to “calculating relative position” and “identifying relative position” as well. The function of calculating relative position of low-resolution data images in this manner is realized by a relative position determining unit 102c (see FIG. 1) which is a functional portion of CPU 102.

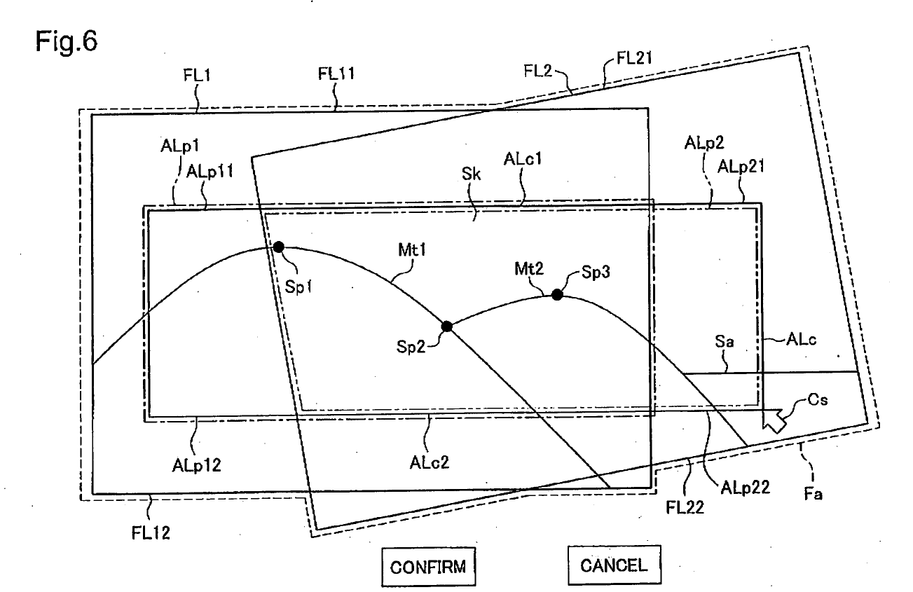

FIG. 6 illustrates a user interface screen for determining an image generation area ALc. Once relative position of low-resolution data FL1, FL2 images is calculated in Step S6 of FIG. 2, an image generation area ALc is then determined in Step S8.

In Step S8, as shown in FIG. 6, CPU 102 displays low-resolution data FL1, FL2 images on display 110, at the relative positions calculated in Step S6. The user then uses the mouse 130 to indicate, within a composite area Fa composed of areas of images recorded by low-resolution data FL1, FL2, an image generation area ALc which is an area for generating a panorama image. In the event that an area larger than area Fa is indicated as the image generation area ALc, an error message is displayed on the display 110, and a prompt to re-select image generation area ALc is displayed.

In FIG. 6, composite area Fa, which represents the total of the areas of images recorded by low-resolution data FL1, FL2, is indicated by broken lines. The broken lines indicating composite area Fa are depicted shifted away from the actual area boundaries, in order to facilitate understanding. The function of determining image generation area in this manner is realized by an image generation area determining unit 102d (see FIG. 1) which is a functional portion of CPU 102.

As shown in FIG. 6, the image generation area ALc indicated by the user is displayed superimposed over the low-resolution data FL1, FL2. In the example of FIG. 6, the image generation area ALc is a rectangle having greater extension laterally, having a range larger than each of the image areas of the low-resolution data FL1, FL2.

After the user has provisionally indicated an image generation area ALc using the mouse 130, it is possible to cancel the indicated image generation area ALc by clicking with the mouse 130 on the “Cancel” button shown on display 110 (see FIG. 6 bottom). A new image generation area ALc can then be indicated. After the user has provisionally indicated an image generation area ALc using the mouse 130, it is possible for the use to make final determination of the image generation area ALc by clicking the “Confirm” button with the mouse 130. In Step S8, image generation area ALc is determined in this manner.

In Embodiment 1, the indicated image generation area ALc is encompassed within the composite area Fa which is the sum of areas of images recorded by low-resolution data FL1, FL2. Thus, tone values of pixels in the panorama image can be calculated accurately on the basis of tone values of pixels of low-resolution data FL1, FL2. In the event that, on the other hand, the indicated image generation area ALc is larger than the composite area Fa, it becomes necessary, over the range outside the areas of the low-resolution data FL1, FL2 images, to determine tone values for pixels in that range by some method, working from a condition in which tone value information for the range is lacking. Quality of the generated panorama image will be lower as a result.

In Embodiment 1, the low-resolution data FL1 image is displayed on display 110 with its long sides FL11, FL12 oriented horizontally. The image generation area ALc indicated by the user is also assumed to be positioned with its long sides ALc1, ALc2 oriented horizontally. As a result, the long sides ALc1, ALc2 of the image generation area ALc are parallel with the long sides FL11, FL12 of the low-resolution data FL1 image, and form a predetermined angle with respect to the long sides FL21, FL22 of the low-resolution data FL2 image.

In Step S10 of FIG. 2, there is calculated a low-resolution partial image, composed of portions of the low-resolution data FL1, FL2 images included in the image generation area ALc. The portion of the low-resolution data FL1 image included in image generation area ALc shall be referred to as low-resolution partial image ALp1; the portion of the low-resolution data FL2 image included in image generation area ALc shall be referred to as low-resolution partial image ALp2. In FIG. 6, low-resolution partial images ALp1, ALp2 are indicated respectively by alternating single-dot/dash lines and alternating double-dot/dash lines. In FIG. 6, the alternating single-dot/dash lines and alternating double-dot/dash lines representing the low-resolution partial images ALp1, ALp2 are depicted shifted away from the actual area boundaries, in order to facilitate understanding of the area of overlap of the low-resolution partial images ALp1, ALp2. The function of calculating low-resolution partial images within low-resolution data image areas is realized by a first partial image determining unit 102e (see FIG. 1) which is a functional portion of CPU 102.

As will be understood from FIG. 6, low-resolution partial images ALp1, ALp2 have areas of mutual overlap. The long sides ALc1, ALc2 of the image generation area ALc (which is a rectangle having greater extension laterally) are parallel with the long sides FL11, FL12 of the low-resolution data FL1 image. Therefore, the upper edge ALp1 and lower edge ALp12 of low-resolution partial image ALp1, which constitute portions of the long sides ALc1, ALc2 of the image generation area ALc, will also be parallel with the long sides FL11, FL12 of the low-resolution data FL1 image.

On the other hand, the long sides ALc1, ALc2 of the laterally extended rectangular image generation area ALc form a predetermined angle with the long sides FL21, FL22 of the low-resolution data FL2 image. Therefore, the upper edge ALp21 and lower edge ALp22 of low-resolution partial image ALp2, which constitute portions of the long sides ALc1, ALc2 of the image generation area ALc, will also form a predetermined angle with the long sides FL21, FL22 of the low-resolution data FL2 image.

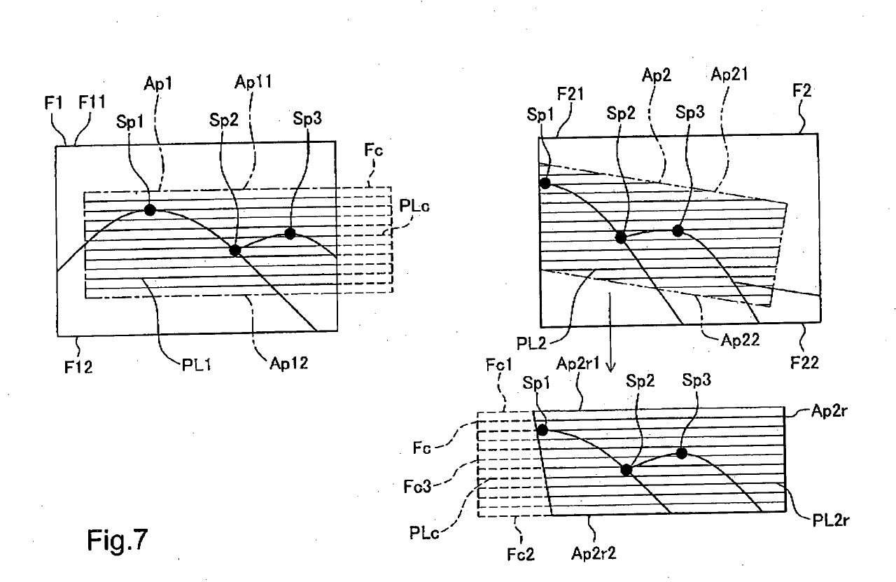

FIG. 7 is an illustration of the relationship between images of original image data F1, F2 and partial images Ap1, Ap2. In Step S12 in FIG. 2, partial images Ap1, Ap2, which represent portions corresponding respectively to low-resolution partial images ALp1, ALp2 in the original image data F1, F2 images, are calculated. Partial image Ap1 is selected from a portion of the original image data F1 image, on the basis of the relative position of partial image Ap1 in the entire area of the low-resolution data FL1 image. Analogously, partial image Ap2 is selected from a portion of the original image data F2 image, on the basis of the relative position of partial image Ap2 in the entire area of the low-resolution data FL2 image. The function of determining partial images from original image data images is realized by a second partial image determining unit 102f (see FIG. 1) which is a functional portion of CPU 102.

As noted, low-resolution partial images ALp1, ALp2 represent areas that include a portion of an image in common. Therefore, partial images Ap1, Ap2 are also areas that include a portion of an image in common. Specifically, both partial images Ap1 and Ap2 include in common an image of portions of mountains Mt1, Mt2 and sky Sk. Characteristic points Sp1-Sp3 established thereon are also included in partial images Ap1, Ap2.

As shown in FIG. 6, upper edge ALp11 and lower edge ALp12 of low-resolution partial image ALp1 are parallel with the long sides FL11, FL12 of the low-resolution data FL1 image. Accordingly, as shown in FIG. 7, the upper edge Ap1l and lower edge Ap12 of partial image Ap1 corresponding to low-resolution partial image ALp1 are also parallel with the long sides F11, F12 of the original image data F1 image. In FIG. 7, the direction in which the pixels making up partial image Ap1 are arrayed is indicated by a plurality of straight lines PL1. The final panorama image Fc is represented by broken lines, and the direction in which the pixels making up panorama image Fc are arrayed is indicated by a plurality of straight lines PLc.

On the other hand, the upper edge ALp21 and lower edge ALp22 of low-resolution partial image ALp2 form a predetermined angle with the long sides FL21, FL22 of the low-resolution data FL2 image, which is the entire image. Accordingly, the upper edge Ap21 and lower edge Ap22 of partial image Ap2 corresponding to low-resolution partial image ALp2 also form a predetermined angle with the long sides F21, F22 of the original image data F2 image. In FIG. 7, the direction in which the pixels making up partial image Ap2 are arrayed is indicated by a plurality of straight lines PL2.

The final panorama image Fc is composed of pixels arrayed along the long sides Fc1, Fc1 and short side Fc3 thereof. As in the original image data F1, F2, each pixel of the panorama image Fc has a tone value representing a color. Tone values of pixels of panorama image Fc are calculated from tone values of those pixels among pixels in original image data F1 that make up partial image Ap1, and tone values of those pixels among pixels in original image data F2 that make up partial image Ap2.

Pixel pitch of the final panorama image Fc is assumed to be equal to pixel pitch in the original image data F1, F2 images. It is assumed that positions of some of the pixels among the pixels that make up the generated panorama image Fc overlap pixel positions of original image data F1. The upper edge Ap1l and lower edge Ap12 of partial image Ap1 are aligned with portions of the upper edge Fc1 and lower edge Fc2 of panorama image Fc. Thus, tone values of those pixels of original image data F1 which make up partial image Ap1 can be used as-is when calculating tone values of pixels making up panorama image Fc.

On the other hand, the upper edge Ap21 and lower edge Ap22 of partial image Ap2 form a predetermined angle to the horizontal direction (which is the same as the direction of the long sides F21, F22 of original image data F2). Thus, prior to synthesizing panorama image Fc from partial image Ap2 and partial image Ap1, partial image Ap2 is subjected to conversion whereby it is rotated and enlarged or reduced. This conversion involving rotation and enlargement/reduction is identical to conversion performed on the low-resolution data FL2 image when calculating relative positions of low-resolution data FL1, FL2 in Step S6 of FIG. 2.

When performing conversion involving rotation and enlargement/reduction on partial image Ap2, affine conversion represented by Equations (1), (2) hereinbelow is performed on partial image Ap2. A converted partial image Ap2R is then generated from partial image Ap2. Equations (1), (2) are equations for use in an x, y coordinate system, to enlarge or reduce by a factor of a in the x direction and a factor of b in the y direction, as well as rotate by θ in the counterclockwise direction, centered on a position (x0, y0), to derive a converted position (X, Y) from the pre-conversion position (x, y).
x={(X−x0)cos θ−(Y−y0)sin θ}/a+x0 (1)
y={(Y−x0)sin θ−(Y−y0)cos θ}/b+y0 (2)

Using the above Equations (1), (2), it is possible to determine the tone value of a pixel at a position (X, Y) converted from a pixel at any location making up partial image Ap2. Pixels making up the converted partial image Ap2r are pixels established at the same locations as the pixels making up the panorama image Fc. For this reason, the following process is performed.

Of pixels established at the same locations as pixels making up the panorama image Fc, the tone value of the pixel located closest to the position (X, Y) given by Equations (1), (2) will have the same value as the “tone value of the pixel at position (x, y) making up partial image Ap2.” In this way, it is possible to assign tone values for the colors red, green and blue, for “pixels established at identical locations to those of pixels that make up panorama image Fc, and corresponding to pixels that make up partial image Ap2.”

When assigning tone values for pixels that correspond to pixels making up partial image Ap2 in the manner described above, the following adjustment is made. Let it be assumed that there is a position (X1, Y1) derived by applying the aforementioned Equations (1), (2) to the position (x1, y1) of a pixel making up partial image Ap2, and a position (X2, Y2) derived by applying the aforementioned Equations (1), (2) to the position (x2, y2) of a different pixel making up partial image Ap2. Let it also be assumed that, of pixels established at identical positions to pixels that make up panorama image Fc, the pixel closest to position (X1, Y1) and the pixel closest to position (X2, Y2) are the same. In such an instance, it is would not be acceptable to assign two sets of tone values to the same given pixel. Thus, in such instances an average value, taken from the tone value of the pixel at position (x1, y1) and the tone value of the pixel at position (x2, y2), is used as the tone value for the “pixel at the closest location.”

In certain instances, certain pixels established at the same positions as pixels making up the panorama image Fc may not be assigned tone values by means of the procedure described above. In such instances, tone values will be assigned by means of interpolation by a predetermined method, based on tone values of pixels that have been assigned tone values.

By means of image conversion as described hereinabove, an image approximating partial image Ap2 can be displayed, and a converted partial image Ap2r composed of pixels that are arrayed along the upper edge Ap2r1 and lower edge Ap2r2 can be generated (FIG. 7). In FIG. 7, the direction in which the pixels making up partial image Ap2 are arrayed is indicated by a plurality of straight lines PL2r. As noted previously, since partial images Ap1 and Ap2 have mutually overlapping areas, partial image Ap1 and converted partial image Ap2r have between them portions representing the same subject. That is, both partial image Ap1 and converted partial image Ap2r include in common an image of portions of mountains Mt1, Mt2 and sky Sk. Characteristic points Sp1-Sp3 established thereon are also included in partial images Ap1, Ap2.

This process is not performed on the entire area of the original image data F2 image, but rather only on the partial image Ap2r contained in the original image data F2 image. Accordingly, less processing is required as compared to the case where image conversion is carried out and tone values are calculated for all pixels included in the area of the original image data F2 image. As a result, less memory is required for the process by computer 100, and calculation time can be reduced.

In Step S6 in FIG. 2, conversion is executed analogously when calculating relative positions of low-resolution data FL1, FL2 images. However, since the low-resolution data FL1, FL2 which is handled in Step S6 has lower pixel density than does the original image data F1, F2, a smaller number of pixels make up the images. Accordingly, the volume of calculations needed to perform rotation and enlargement/reduction conversion of low-resolution data FL2 to arrive at tone values for pixels in Step S6 is smaller, as compared to that needed to perform the same conversion and arrive at pixel tone values for original image data F2.

For reasons such as that cited hereinabove, where the number of pixels of low-resolution data is established at a level lower, by a predetermined percentage, than the number of pixel of the original image data, it is possible to further reduce the volume of calculations when performing rotation and enlargement/reduction conversion directly on original data, even where the volume of calculations when identifying relative position of low-resolution data in Step S6 in FIG. 2 and the volume of calculations when performing conversion of partial images in Step S14 are combined. In Embodiment 1, pixel pitch of low-resolution data image is 50% of the pixel pitch of original image data images. Thus, even where the volume of calculations in Step S6 and Step S14 are combined, the total will be less than the volume of calculations required when performing rotation and enlargement/reduction conversion directly on original data.

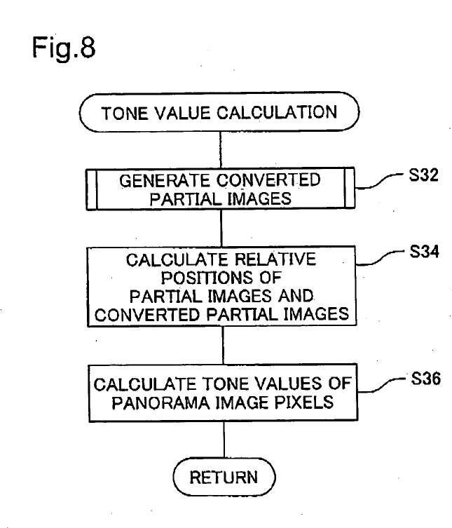

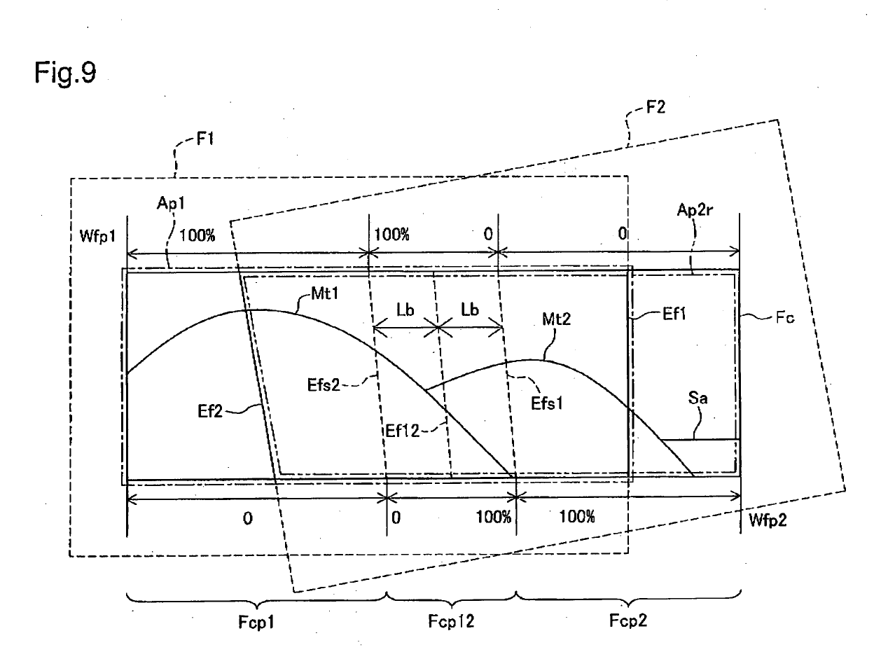

FIG. 9 is an illustration of relationships among tone values of pixels of partial image Ap1, tone values of pixels of converted partial image Ap2r, and tone values of pixels of panorama image Fc. Once the converted partial image is generated in Step S32 of FIG. 8, next, in Step S34, relative position of the partial image and converted partial image is calculated. Relative position of partial image Ap1 and converted partial image Ap2r is calculated on the basis of the relative positions of the low-resolution data FL1, FL2 images derived in Step S6 of FIG. 2. As a result, relative position of partial image Ap1 and converted partial image Ap2r is identified as shown in FIG. 9.

In Step S36 of FIG. 8, tone values of the pixels of panorama image Fc are calculated. The area of the synthesized panorama image Fc is divided into three portions. The boundary Ef12 indicated by the broken line at center in FIG. 9 is a boundary line situated medially between Ef1, which is the right edge of partial image Ap1, and Ef2 which is the left edge of converted partial image Ap2r. In Step S36, once relative position of partial image Ap1 and converted partial image Ap2r has been identified, this boundary Ef12 is then calculated. The area of panorama image Fc is divided into a boundary area Fcp12 centered on this boundary Ef12 and extending over a range of distance Lb to the right and left thereof, a left side area Fcp1 located to the left of boundary area Fcp12, and a right side area Fcp2 located to the right of boundary area Fcp12.

Of the pixels of panorama image Fc, pixels in the left side area Fcp1 have tone values Vc equivalent to the tone values Vb1 of pixels of partial image Ap1 positioned overlapping the former pixels. Of the pixels of panorama image Fc, pixels in the right side area Fcp2 have tone values Vc equivalent to the tone values Vb2 of pixels of converted partial image Ap2r positioned overlapping the former pixels. Of the pixels of panorama image Fc, pixels in the boundary area Fcp12 have tone values Vc calculated from tone values Vb1 of pixels of partial image Ap1 and tone values Vb2 of pixels of converted partial image Ap2r, positioned overlapping the former pixels.

The pixels that make up the generated panorama image Fc are established such that certain of these pixels are superimposed over pixel positions in the original image data F1. The entire image of left side area Fcpl is included within partial image Ap1, which is part of the original image data F1 image. Accordingly, in left side area Fcp1, of the pixels that make up the generated panorama image Fc, for those pixels that are superimposed over pixel positions in the original image data F1, i.e. that are superimposed over pixel positions in partial image Ap1, tone values Vb1 of the pixels of partial image Ap1 may serve as-is as tone values Vc of pixels of panorama image Fc.

In panorama image Fc, tone values of the pixels of the right side area Fcp2 are calculated as follows. First, average luminance Lm1 of the pixels of partial image Ap1 and average luminance Lm2 of the pixels of partial image Ap2 are calculated. Next, the value ΔV is calculated on the basis of Lm1 and Lm2, using Equation (3) below. Here, a is a predetermined coefficient.
ΔV=a(Lm1−Lm2) (3)

The entire image of right side area Fcp2 is included within converted partial image Ap2r. Accordingly, tone values Vc of the pixels of right side area Fcp2 are derived from tone values of the pixels of converted partial image Ap2r and ΔV, using Equation (4) below. Here, Vb2 is the tone value of a pixel of converted partial image Ap2r at a position coinciding with the pixel targeted for the tone value calculation.
Vc=Vb2+ΔV (4)

That is, in Embodiment 1, deviation AV between average luminance Lm1 of the pixels of partial image Ap1 and average luminance Lm2 of the pixels of partial image Ap2 is calculated. Next, in order to cancel out this deviation, tone values Vb2 of the pixels of converted partial image Ap2r are shifted by ΔV, to derive tone values Vc for the pixels of the right side area Fcp2 of panorama image Fc. Thus, even in the event that overall luminance differs among portions generated from different sets of original image data, a panorama image Fc produced therefrom will not have an unnatural appearance.

In panorama image Fc, boundary area Fcp12 includes areas of both partial image Ap1 and converted partial image Ap2r. Tone values Vc of pixels of boundary area Fcp12 are derived from tone values Vb1 of the pixels of partial image Ap1 and tone values Vb2 of the pixels of converted partial image Ap2r. That is, in a manner analogous to Equation (4), tone values Vb2 of the pixels of converted partial image Ap2r are shifted, the shifted tone values (Vb2+ΔV) and tone values Vb1 of the pixels of partial image Ap1 are weighted and averaged, and tone values Vc of the pixels of boundary area Fcp12 in panorama image Fc are calculated.

Specifically, tone values Vc of the pixels of boundary area Fcp12 are calculated using Equation (5) below. Here, Wfp1 and Wfp2 are constants such that (Wfp1+Wfp2)=1. At the left edge Efs2 of boundary area Fcp12, Wfp1=1 and Wfp2=0. Within boundary area Fcp12, Wfp2 increases moving rightward, so that at the right edge Efs1 of boundary area Fcp12 Wfp1=0 and Wfp2=1. The value of Wfp1, expressed as a percentage, is shown above panorama image Fc; the value of Wfp2, expressed as a percentage, is shown below panorama image Fc.
Vc=(Wfp1×Vb1)+{Wfp2×(Vb2+ΔV)} (5)

For example, tone values of pixels situated at the left edge Efs2 of boundary area Fcp12 are equivalent to the tone values of pixels of partial image Ap1 situated at the same pixel positions. Within boundary area Fcp12, the proportion of tone values of pixels of partial image Ap1 reflected in tone values of pixels of panorama image Fc decreases moving rightward, with tone values of pixels situated at the right edge Efs1 of boundary area Fcp12 being equivalent to tone values Vb2 of pixels of converted partial image Ap2r situated at the same pixel positions, modified in the manner described above (i.e. Vb2+ΔV).

In Step S36 of FIG. 8, tone values of pixels of panorama image Fc are calculated from tone values of pixels of the original image data F1 image and tone values of pixels of the converted partial image Ap2r in the manner described above. The process for calculating tone values of pixels of panorama image Fc, depicted by the flowchart of FIG. 8, then terminates. In Embodiment 1, since tone values of pixels of panorama image Fc are calculated by this method, the panorama image Fc obtained thereby has no noticeable seam between the original image data F1 and F2 images.

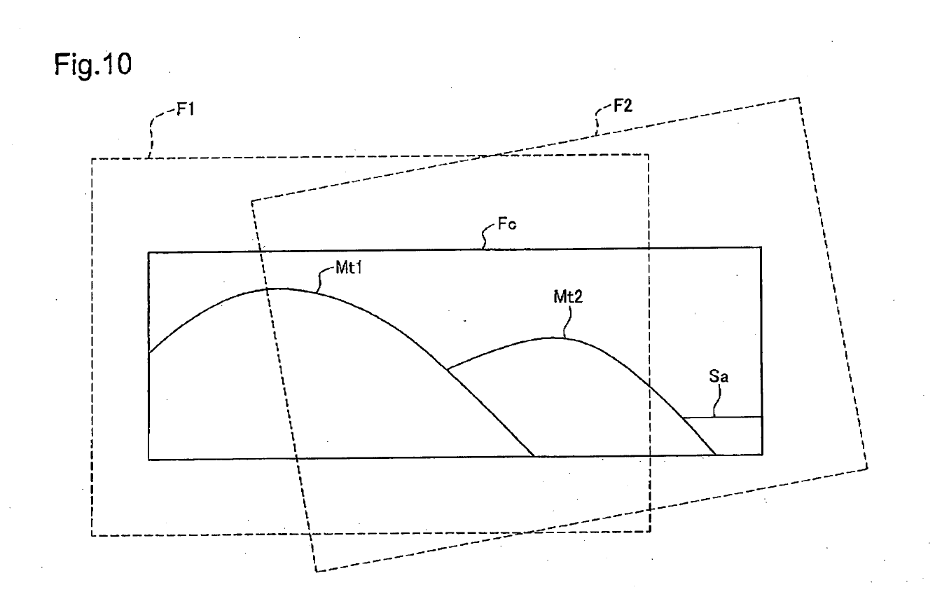

FIG. 10 is an illustration of the relationship between the range of panorama image Fc generated in the above manner, and the ranges of original image data F1, F2 images. In Step S14 of FIG. 2, after tone values of pixels of panorama image Fc have been calculated in the above manner, CPU 102 then generates panorama image Fc image data that includes data for tone values of these pixels, and that has a range greater than the range of the original image data F1 or F2 images. The function of calculating tone values for pixels of panorama image Fc and generating image data for panorama image Fc in this manner is realized by an extended image generating unit 102g (see FIG. 1) which is a functional portion of CPU 102.

This tone value calculation is not performed for all areas of the original image data F1, F2 images, but rather only for pixels situated within the areas of partial images Ap1, Ap2, in other words, for pixels situated within the area of panorama image Fc. Accordingly, the volume of calculations required when generating the panorama image is smaller as compared to the case where tone values are calculated for pixels in the areas of the original image data F1, F2 images. As a result, less memory is required for the process by computer 100, and calculation time can be reduced.

### B. Embodiment 2

In Embodiment 1, a panorama image Fc is generated after first generating an entire converted partial image Ap2r from partial image Ap2. In Embodiment 2, however, rather than generating the entire converted partial image Ap2r in advance, when calculating tone values of pixels that make up panorama image Fc, tone values of pixels for the corresponding converted partial image are calculated at the same time, and the panorama image Fc is generated.

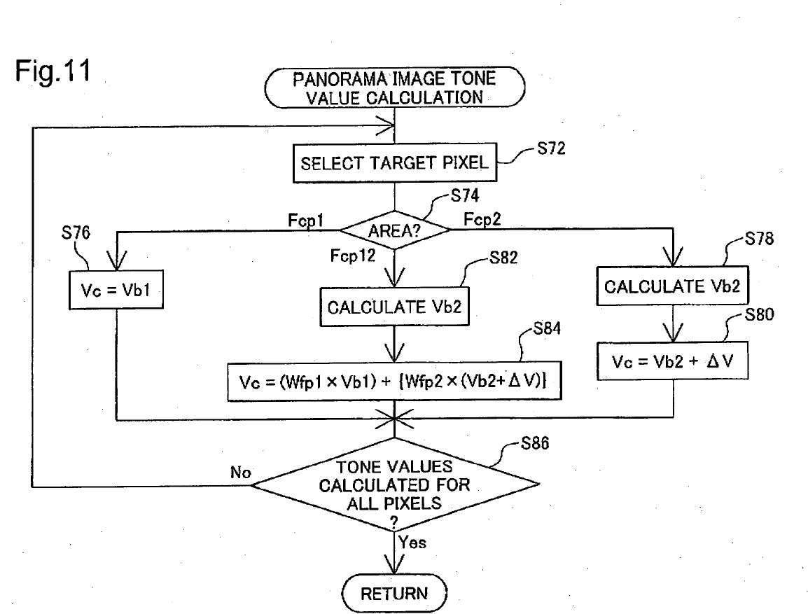

FIG. 11 is a flowchart showing a procedure for calculating tone values of pixels of panorama image Fc from tone values of pixels of partial images Ap1, Ap2. In Embodiment 2, when calculating tone values of pixels that make up panorama image Fc, in Step S72, there is first selected a target pixel for calculating tone value, from among the pixels that make up panorama image Fc.

In Step S74, a decision is made as to whether the target pixel is a pixel belonging to the left side area Fcp1, right side area Fcp2, or boundary area Fcp12 (see FIG. 9). In the event that the target pixel is a pixel belonging to the left side area Fcp1, in Step S76, the tone value of the pixel in partial image Ap1, situated at the same position as the target pixel, is designated as the tone value Vc for the target pixel.

In Step S74, in the event that the target pixel is a pixel belonging to the right side area Fcp2, in Step S78 the tone value Vb2 of a pixel established at the same position as the target pixel is calculated from the tone value of a pixel in partial area Ap2. For example, an inverse conversion of the affine conversion represented by Equations (1), (2) is performed on the position (X, Y) of a pixel established at the same position as the target pixel, to arrive at a position (x, y). Next, the tone value of the pixel at the position closest to position (x, y) among the pixels that make up partial area Ap2 is selected as the tone value Vb2 for the pixel at position (X, Y). Then, in Step S80, a tone value Vc for the target pixel is calculated according to Equation (4).

In Step S74, in the event that the target pixel is a pixel belonging to the boundary area Fcp12, in Step S82 the tone value Vb2 of a pixel Ps1 established at the same position as the target pixel is calculated by the same procedure as in Step S78, to calculate a tone value for the pixel in partial image Ap2. Then, in Step S84, a tone value Vc for the target pixel is calculated according to Equation (5).

In Step S86, a decision is made as to whether tone values have been calculated for all pixels of panorama image Fc. If there are still pixels for which tone value has not been calculated, so that that decision result is No, the routine goes back to Step S72. If in Step S86 it is decided that tone values have been calculated for all pixels of panorama image Fc, so that that decision result is Yes, the process of calculating tone values for pixels of panorama image Fc terminates.

By means of the procedure described hereinabove, tone values for the pixels that make up panorama image Fc can be calculated without generating an entire converted partial image Ap2r from partial image Ap2 in advance. In such a process as well, tone values are calculated only for the pixels that make up the panorama image Fc. That is, it is not the case that tone values are calculated for pixels over an entire area which is the sum of the areas of images recording original image data. Accordingly, less calculation is needed when generating data for the panorama image Fc.

### C. Embodiment 3

Embodiment 3 differs from Embodiment 1 in terms of the relationship between original image data and panorama image data, and the number of original image data. In other respects, it is the same as Embodiment 1.

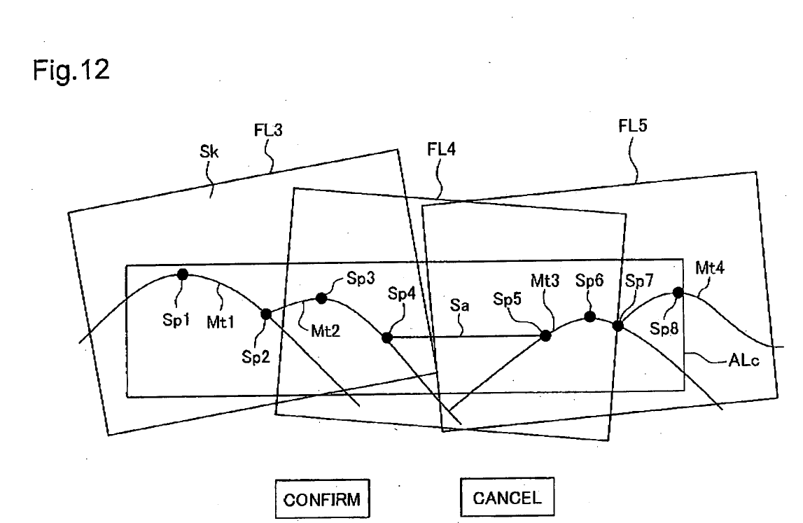

FIG. 12 illustrates a user interface screen displayed when determining an image generation area ALc on display 110 in Embodiment 3. In Embodiment 3, a single panorama image Fc is synthesized from original image data F3, F4, F5. Original image data F3, F4, F5 represent three sets of image data taken, while shifting the frame, of a landscape in which mountains Mt1-Mt4, ocean Sa, and sky Sk are visible.

In Embodiment 3, low-resolution data FL3, FL4, FL5 is generated from the original image data F3, F4, F5 in Step S4 of FIG. 2. Next, in Step S6, relative positions of the images represented by the low-resolution data FL3, FL4, FL5 are calculated. For example, relative positions of the low-resolution data FL3 image and the low-resolution data FL4 image are determined such that deviations among characteristic points Sp3 and among characteristic points Sp4 lie respectively within predetermined ranges. Relative positions of the low-resolution data FL4 image and the low-resolution data FL5 image are determined such that deviations among characteristic points Sp5 and among characteristic points Sp6 lie respectively within predetermined ranges.

In Embodiment 1, relative positions of the low-resolution data FL1 and FL2 images are defined such that, for all established characteristic points Sp1-Sp3, deviation in position among them is within a predetermined range. However, when calculating relative position, it is not necessary to calculate relative position such that all characteristic points coincide. However, in preferred practice, relative position will be calculated such that, for at least two characteristic points, the extent of deviation of each is within a predetermined range.

In Step S8 in FIG. 2, an image generation area ALc is designated by the user. As shown in FIG. 12, in Embodiment 3, none of the sides of the image generation area ALc are parallel with any of the sides of the low-resolution data FL3, FL4, FL5 images. As a result, the direction in which pixels are arrayed in the final panorama image Fc does not coincide with the direction in which pixels are arrayed in any of the original image data F3, F4, F5 images. Accordingly, the direction in which pixels are arrayed in partial images generated in Step S12 of FIG. 2 does not coincide with the direction in which pixels are arrayed in the final panorama image Fc.

In Embodiment 3, when calculating tone values of pixels of panorama image Fc, in Step S32 of FIG. 8, affine conversion analogous to that carried out on partial images Ap2 in Embodiment 1 is performed on all of the partial images Ap3, Ap4, Ap5 generated from the original image data F3, F4, F5, to generate converted partial images Ap3r, Ap4r, Ap5r. Then, in Step S34, relative positions are determined among the converted partial images Ap3r, Ap4r, Ap5r. The method for determining relative position is similar to the method of determining relative position for the low-resolution data FL3, FL4, FL5. The, in Step S36, tone values for the panorama image Fc are calculated.

In Embodiment 3, converted partial images are generated for all partial images that have been generated from the original image data F3, F4, F5. It is accordingly possible to produce a panorama image of free orientation and shape, unconstrained by the orientation of the original image data images.

### D: Variations

The invention is in no way limited to the embodiments and embodiments disclosed hereinabove, and may be reduced to practice in various aspects without departing from the scope and spirit thereof, with variations such as the following being possible, for example.

In Embodiment 1, partial images Ap1, Ap2, which are portions corresponding respectively to low-resolution partial images ALp1, ALp2, were calculated from original image data F1, F2. Conversion involving rotation and enlargement/reduction was then performed for the partial image Ap2 whose own pixel array direction PL2 forms a predetermined angle with respect to the direction of the sides Fc1, Fc2 of the generated panorama image Fc (i.e., pixel array direction PLc). However, this process could be performed on a predetermined processing area that includes other areas, rather than only for the partial image Ap2 selected from a portion of the original image data F2 image.

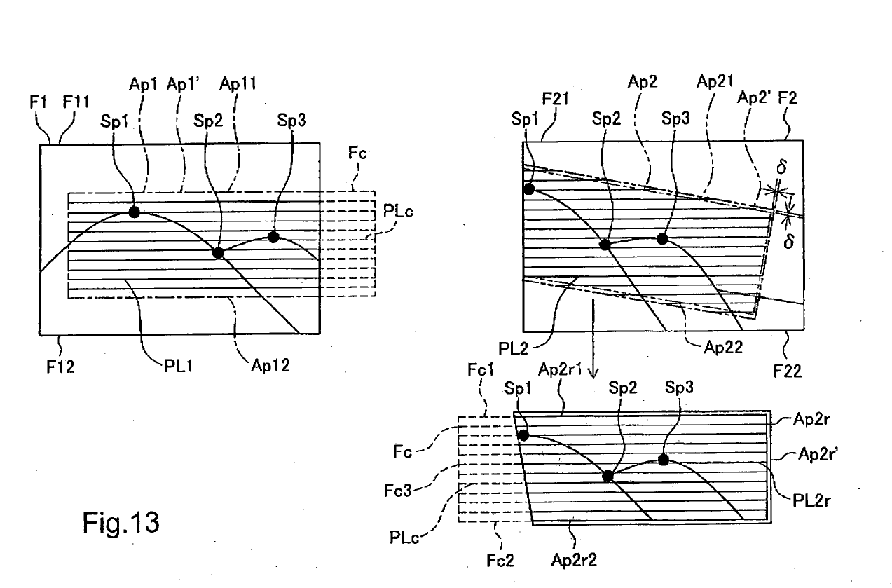

FIG. 13 is an illustration of relationships among original image data F1, F2 images, partial images Ap1, Ap2, and processing areas Ap1′, Ap2′. In the original image data F1 shown at left in FIG. 13, partial image Ap1 and processing area Ap′, used for generating panorama image Fc, are the same area. In contrast to this, in the original image data F2 shown at right in FIG. 13, processing area Ap2′, which performs a predetermined process for use in generating panorama image Fc, is a predetermined area that includes partial image Ap2 and another area outside partial image Ap2.

Processing area Ap2′ is an area that includes partial image Ap2, and an area within a range of predetermined distance δ from the perimeter of partial image Ap2. In the embodiment of FIG. 13, conversion involving rotation and enlargement/reduction is performed for this processing area Ap2′, to generate a converted processing area Ap2r′. Next, a converted partial image Ap2r, which is a portion corresponding to low-resolution partial image ALp2, is extracted from the converted processing area Ap2r′. Using the method described in Embodiment 1, a panorama image Fc is then generated using the converted partial image Ap2r.

By means of such an aspect, converted processing area Ap2r′ can be generated by conversion involving rotation and enlargement/reduction performed in consideration of an area greater than the area of partial image Ap2. Thus, image quality can be enhanced in proximity to the perimeter of the converted partial image Ap2r extracted from converted processing area Ap2r′.

Processing area Ap2′ can be generated, for example, from the area of partial image Ap2 and an area within a distance range equivalent to three times the length of one side of a pixel in the main scanning direction or sub-scanning direction, from the perimeter of partial image Ap2. Processing area Ap2′ can also be generated, for example, from the area of partial image Ap2 and an area within a distance range equivalent to twice the length of one side of a pixel from the perimeter of partial image Ap2. However, the processing area for performing a predetermined process in order to generate composite image Fc is not limited to such embodiments, it being possible to select any area that includes a partial original image. As with the original image data F1 of FIG. 13 or Embodiment 1, the processing area for performing a predetermined process can be an area equivalent to the area of the partial original image.

In Embodiment 1, the pixel density of the generated panorama image was the same as the pixel density of the original image data. However, the pixel density of the generated panorama image may differ from the pixel density of the original image data. Where the pixel density of the generated panorama image differs from the pixel density of the original image data, when generating a converted partial image in Step S32 of FIG. 8, the converted partial image may be generated at the same pixel density as the pixel density of the generated panorama image.

Also, in Embodiment 1, the pixel density of the low-resolution data F1, F2 was 50% of the pixel density of the original image data. However, pixel density of an image (low-resolution data) generated by resolution conversion of an acquired image (original image data) is not limited thereto, provided it is lower than the pixel density of the acquired image. In preferred practice, however, pixel pitch of the image generated by resolution conversion will be 30%-80% of the pixel pitch of the acquired image, more preferably be 40%-60% of the pixel pitch of the acquired image.

In preferred practice, pixel pitch of the image generated by resolution conversion will be 1/n. Here, n is a positive integer. By means of such an embodiment, it is possible to reduce the amount of calculation required when performing resolution conversion. Also, degradation of picture quality in the generated image is negligible.

When determining relative positions of a plurality of images that include image portions in common, in the event that the images are arrayed in substantially a single row in one direction as depicted in FIG. 12, the user may use the keyboard 120 to input to the computer 100 a number or symbol indicating an order for arraying the images, rather than dragging each image on the user interface screen using the mouse.

In Embodiment 1, for the partial image Ap1 that is one of the partial images, pixel tone values were used as-is, whereas for the other partial image Ap2, tone values were adjusted so as to bring average luminance into approximation with the average luminance of partial image Ap1 (see Equation (4)). However, tone value adjustment is not limited to tone value adjustment carried out in such a way as to bring tone values of the other partial image into line with tone values of the partial image serving as a benchmark. That is, embodiments wherein tone value adjustment is carried out such that deviation of a evaluation value, such as luminance, among all partial images is brought to within a predetermined range would also be acceptable.

In the embodiments hereinabove, each pixel of original image data has color tone values for red, green and blue. However, embodiments wherein pixels of original image data have tone values for other color combinations, such as cyan, magenta and yellow, would also be acceptable.

In the embodiments hereinabove, some of the arrangements realized by means of hardware could instead by replaced with software; conversely, some of the arrangements realized by means of software could instead by replaced with hardware. For example, processes performed by the low-resolution data conversion portion, relative position determining unit, or other functional portion could be carried out by hardware circuits.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

The program product may be realized as many aspects. For example:
(i) Computer readable medium, for example the flexible disks, the optical disk, or the semiconductor memories;
(ii) Data signals, which comprise a computer program and are embodied inside a carrier wave;
(iii) Computer including the computer readable medium, for example the magnetic disks or the semiconductor memories; and
(iv) Computer temporally storing the computer program in the memory through the data transferring means.

1. Method for generating a panorama image from a plurality of original images that include an image in common, the method comprising the steps of:
(a) generating from each of the original images a low-resolution image having lower resolution than the original image;
(b) identifying a condition of overlap for the low-resolution images which is to be identified based on areas for the image in common, in order to determine a feasible area in which the panorama image may be generated;
(c) determining within the feasible area an area extending beyond an area of any one of the low-resolution images, as an image generation area for generating the panorama image; and
(d) generating from the plurality of original images a panorama image having an area corresponding to the image generation area.

2. Image generating method for generating a composite image from a plurality of original images, the method comprising:
determining a plurality of partial original images for inclusion in the composite image to be generated, and included in any of the plurality of original images; and
performing a predetermined process for generating the composite image on a predetermined processing area of the original image that includes the partial original image, without performing the process on portions outside the processing area, to generate the composite image based on the plurality of partial original images.

3. Image generating method according to claim 2 wherein the processing area includes:
an area included within the original image and within a range of predetermined distance from the perimeter of the partial image, and
the area of the partial original image.

4. Image generating method according to claim 2 wherein the processing area is equivalent to the area of the partial original image.

5. Image generating method according to claim 4 wherein the composite image has higher density of pixels making up the image than does the low-resolution image, and an area extending beyond an area of any one of the original images.

6. Image generating method according to claim 4 wherein the predetermined process for generating the composite image calculates pixel tone values, and
the step of generating the composite image comprises the step of calculating the tone value of each pixel making up the composite image, based on the tone value of each pixel making up the plurality of partial original images, without calculating tone values of pixels not included in the composite image.

7. Image generating method according to claim 4 wherein the plurality of original images mutually include portions recording a same given subject, and the step of determining partial original images comprises the steps of:
(a) performing resolution conversion for the plurality of original images, to generate a plurality of low-resolution images of resolution lower than the original images;
(b) based on portions in the low-resolution image recording the same given subject, determining from areas of the plurality of low-resolution images a composite area equivalent to the sum of the areas of the low-resolution images;
(c) determining within the composite area an image generation area extending beyond an area of any one of the low-resolution images; and
(d) determining, as the partial original images, portions of the original images corresponding to low-resolution partial images which are portions of the low-resolution images and included in the image generation area.

8. Image generating method according to claim 7 wherein
the partial original image, when subjected to conversion of the resolution, is to generate an image equivalent to one of the low-resolution partial images, and
the step (d) comprises the step of determining the partial original image based on relationship between the low resolution partial image and the low resolution image, on and the plurality of original images.

9. Image generating method according to claim 7 wherein the low-resolution image has a pixel pitch that is 30%-80% of a pixel pitch of the original image.

10. Image generating method according to claim 7 wherein the step (b) comprises the step of
(b1) based on the portions recording the same given subject, calculating relative positions of the plurality of low-resolution images, and the step (c) comprises the steps of
(c1) displaying as the composite area on a display unit the plurality of low-resolution images according to the relative positions thereof,
(c2) provisionally establishing the image generation area;
(c3) displaying on the display unit the provisionally established image generation area, shown superimposed on the plurality of low-resolution images;
(c4) resetting the image generation area; and
(c5) determining the reset image generation area as the image generation area.

11. Image generating method according to claim 10 wherein the step (b1) comprises the steps of:
(b2) receiving user instruction in regard to general relative position of the plurality of low-resolution images; and
(b3) based on relative position instructed by the user, calculating relative position of the plurality of low-resolution images so that deviation among the portions thereof recording the same given subject is within a predetermined range.

12. Image generating method according to claim 11 wherein the step (b2) comprises the step of displaying on a display unit at least two of the low-resolution images, and
the instruction regarding general relative position of the plurality of low-resolution images is accomplished at least in part by the user moving one of the two low-resolution images displayed on the display unit, onto the other low-resolution image so that they partially overlap.

13. Image generating method according to claim 11 wherein the step (b2) comprises
the step of receiving, by way of instruction in regard to the relative position of the plurality of low-resolution images, instruction relating to sequential order of the plurality of low-resolution images in a predetermined direction, and
the step (b1) further comprises
(b4) a step of determining the relative position of the plurality of low-resolution images according to the sequential order.

14. Image generating device for generating a panorama image from a plurality of original images that include an image in common, comprising:
a low-resolution image generating unit configured to generate from each of the original images a low-resolution image having lower resolution than the original image;
a feasible area determining unit configured to identify a condition overlap for the low-resolution images which is to be identified based on areas for the image in common, in order to determine a feasible area in which the panorama image may be generated;
a generation area determining unit configured to determine within the feasible area an area extending beyond an area of any one of the low-resolution images, as an image generation area for generating the panorama image; and
an extended image generating unit configured to generate from the plurality of original images a panorama image having an area corresponding to the image generation area.

15. Image generating device for generating a composite image from a plurality of original images, wherein the device
determines a plurality of partial original images for inclusion in the composite image to be generated, and included in any of the plurality of original images; and
performs a predetermined process for generating the composite image on a predetermined processing area of the original image that includes the partial original image, without performing the process on portions outside the processing area, to generate the composite image based on the plurality of partial original images.

16. Image generating device according to claim 15 wherein the processing area includes:
an area included within the original image and within a range of predetermined distance from the perimeter of the partial image, and
the area of the partial original image.

17. Image generating device according to claim 15 wherein the processing area is equivalent to the area of the partial original image.

18. Image generating device according to claim 17 wherein
the composite image has higher density of pixels making up the image than does the low-resolution image, and an area extending beyond an area of any one of the original images.

19. Image generating device according to claim 17 wherein the predetermined process for generating the composite image calculates pixel tone values, and
when generating the composite image,
the tone value of each pixel making up the composite image is calculated based on the tone value of each pixel making up the plurality of partial original images,
without calculating tone values of pixels not included in the composite image.

20. Image generating device according to claim 17 wherein the plurality of original images mutually include portions recording a same given subject, and wherein the device comprises:
a low-resolution image generating unit configured to perform resolution conversion for the plurality of original images, to generate a plurality of low-resolution images of resolution lower than the original images;
a composite area determining unit configured to determine, based on portions in the low-resolution image recording the same given subject, a composite area equivalent to the sum of areas of the low-resolution images, from the plurality of low-resolution images;
a generation area determining unit configured to determine within the composite area an image generation area extending beyond an area of any one of the low-resolution images; and
a partial image generating unit configured to determine, as the partial original images, portions of the original images corresponding to low-resolution partial images which are portions of the low-resolution images and included in the image generation area.

21. Image generating device according to claim 20 wherein
the partial original image, when subjected to conversion of the resolution, is to generate an image equivalent to one of the low-resolution partial images, and
the partial image generating unit determines the partial original image based on relationship between the low resolution partial image and the low resolution image, and on the plurality of original images.

22. Image generating device according to claim 20 wherein the low-resolution image has a pixel pitch that is 30%-80% of a pixel pitch of the original image.

23. Image generating device according to claim 20 further comprising a display unit able to display images, wherein
the composite area determining unit is able to calculate, based on the portions recording the same given subject, the relative positions of the plurality of low-resolution images; and
the generation area determining unit
is able to display as the composite area on a display unit, the plurality of low-resolution images according to the relative positions thereof,
is able to receive instructions to provisionally establish the image generation area;
is able to display on the display unit the provisionally established image generation area, shown superimposed on the plurality of low-resolution images;
is able to receive instructions to reset the image generation area; and
determines the reset image generation area as the image generation area.

24. Image generating device according to claim 23 wherein
the composite area determining unit
receives user instruction in regard to general relative position of the plurality of low-resolution images; and
based on relative position instructed by the user, calculates relative position of the plurality of low-resolution images so that deviation among the portions thereof recording the same given subject is within a predetermined range.

25. Image generating device according to claim 24 further comprising a display unit able to display images, wherein
the composite area determining unit displays on the display unit at least two of the low-resolution images, and
the instruction regarding general relative position of the plurality of low-resolution images is accomplished at least in part by the user moving one of the two low-resolution images displayed on the display unit, onto the other low-resolution image so that they partially overlap.

26. Image generating device according to claim 24 wherein
the composite area determining unit
receives, by way of instruction in regard to the relative position of the plurality of low-resolution images, instruction relating to sequential order of the plurality of low-resolution images in a predetermined direction, and
determines the relative position of the plurality of low-resolution images according to the sequential order.

27. Computer program product for generating a panorama image from a plurality of original images that include an image in common, the computer program product comprising:
a computer-readable medium; and
a computer program recorded onto the computer-readable medium;
wherein the computer program comprises:
a portion for generating from each of the original images a low-resolution image having lower resolution than the original image;
a portion for identifying a condition of overlap for the low-resolution images which is to be identified based on areas for the image in common, in order to determine a feasible area in which the panorama image may be generated;
a portion for determining within the feasible area an area extending beyond an area of any one of the low-resolution images, as an image generation area for generating the panorama image; and
a portion for generating from the plurality of original images a panorama image having an area corresponding to the image generation area.

28. Computer program product for generating a composite image from a plurality of original images, the computer program product comprising:
a computer-readable medium; and
a computer program recorded onto the computer-readable medium;
wherein the computer program comprises:
a first portion for determining a plurality of partial original images for inclusion in the composite image to be generated, and included in any of the plurality of original images; and
a second portion for performing a predetermined process for generating the composite image on a predetermined processing area of the original image that includes the partial original image, without performing the process on portions outside the processing area, to generate the composite image based on the plurality of partial original images.

29. Computer program product according to claim 28 wherein
the processing area includes:
an area included within the original image and within a range of predetermined distance from the perimeter of the partial image, and
the area of the partial original image.

30. Computer program product according to claim 28 wherein
the processing area is equivalent to the area of the partial original image.
